(19) United States
(12) Patent Application Publication
(10) Pub. No.: US 2006/0280915 A1
(43) Pub. Date: Dec. 14, 2006

(54) Laminated release film

(76) Inventors: Hideki Kitamura, Fukushima (JP); Hisaaki Terashima, Fukushima (JP); Kazuyuki Suzuki, Fukushima (JP); Yasuhiro Suzuki, Fukushima (JP); Mitsuru Ito, Fukushima (JP); Hiroshi Sato, Fukushima (JP); Takeshi Nakadai, Fukushima (JP); Hideo Yusa, Fukushima (JP); Toshimi Murayama, Fukushima (JP)

Correspondence Address: REED SMITH LLP, 3110 FAIRVIEW PARK DRIVE, FALLS CHURCH, VA, 22042, US

(21) Appl. No.: 11/357,086

(22) Filed: Feb. 21, 2006

(30) Foreign Application Priority Data
Feb. 21, 2005 (JP) JP 2005/044403
Jan. 31, 2006 (JP) JP 2006/022978

(51) Int. Cl. B32B 27/32; B32B 27/38

(52) U.S. Cl. 428/192; 428/523; 428/220; 428/413

(57) ABSTRACT

A release film comprising a resin-based material containing a cycloolefin-based resin.

### BACKGROUND OF THE INVENTION

1. Field of the Invention

The present invention relates to a release film excellent in the thermal resistance, release characteristic and anti-staining characteristic, to a laminated release film having this release film on a surface thereof, and to methods of producing the same.

2. Related Background Art

In production processes for printed wiring boards, flexible printed wiring boards, multilayer printed wiring boards or the like, a release film is used in hot-pressing a copper clad laminate or copper foil through a prepreg or heat-resistant film. Moreover, in the production processes of flexible printed wiring boards, a method using a release film is widely carried out to prevent adhesion between a cover lay film and a press hot plate in hot-press bonding the cover lay film to a flexible printed wiring board body in which electrical circuit is formed, by means of heat-curing type adhesives. Furthermore, the release film is used also in a blind via used for a three-dimensional wiring between the layers of a multilayer printed wiring board, and it is also used in hot-press forming an epoxy prepreg.

As the release film used for these applications, a fluorine-containing film, a silicone coating polyethylene-terephthalate film, a poly methyl pentene film, a polypropylene film, or the like has been used. However, although the fluorine-containing film conventionally used as the release film is excellent in thermal resistance, release characteristic, and anti-staining characteristic, there are problems that it is expensive and additionally hard to burn in disposal incineration after use, and that it generates a toxic gas. Moreover, the silicone-coating polyethylene-terephthalate film and poly methyl pentene film may cause contamination on the printed wiring board, especially on the copper circuit due to the migration of silicon and a low-molecular weight body which is a constituent, thereby damaging the quality. Moreover, the polypropylene film has a poor thermal resistance and inadequate release characteristic.

In Japanese Unexamined Patent Application Publication No. 2004-2592 (Document 1), there is proposed a sheet having a polar group and comprising a resin composite whose halogen content is 5% or less by weight. The sheet has a storage modulus of 1000 to 5000 MPa at 23° C., and has a storage modulus of 20 to 100 MPa at 170° C. The sheet is excellent in flexibility, thermal resistance, release characteristic, and anti-staining characteristic at high temperatures. The sheet is easily disposed after use. A sheet made by extrude-molding a resin composite comprising PELPLENE P450B from T dice is disclosed as a specific example. In Japanese Unexamined Patent Application Publication No. 2004-156048 (Document 2), there is disclosed an invention of a film made by making thinner a resin composite comprising a cyclic olefin-based resin and a styrene-based elastomer, the film being excellent in transparency and toughness. The film comprises the cyclic olefin-based resin in which the difference in the refractive indexes between these cyclic olefin-based resins and styrene-based elastomer, and the weight ratio thereof are within a specific range. There is described that this film is suitable for various optical applications, for example, a phase difference film, a polarizing plate (a deflecting plate) protection film, a light-scattering plate, or the like, and especially suitable for applications to prism sheets and liquid crystal cell substrates.

### SUMMARY OF THE INVENTION

The present invention is intended to provide a release film excellent in the thermal resistance, release characteristic, and anti-staining characteristic. Moreover, the present invention is intended to provide a laminated release film having this release film prepared in the surface layer thereof. Furthermore, the present invention is intended to provide a laminated release film having a sufficient cushioning characteristic at operating temperatures, wherein contaminants are difficult to flow out of the film end face.

The inventors found out that the film obtained from a cycloolefin-based resin, or a resin composite containing a cycloolefin-based resin and a polyolefin other than the cycloolefin-based resin, has excellent detachability, and came to complete the present invention.

The release film of the present invention comprises a resin-based material containing a cycloolefin-based resin. Moreover, in the release film of the present invention, it is preferable that the resin-based material comprises the cycloolefin-based resin described above. Furthermore, in the release film of the present invention, it is preferable that the resin-based material comprises a resin composite containing the cycloolefin-based resin as a main component.

Moreover, in the release film of the present invention, it is preferable that the resin composite contains 1 to 100 parts by weight of the polyolefin other than the cycloolefin-based resin, per 100 parts by weight of the cycloolefin-based resin. Moreover, in the release film of the present invention, it is preferable that the polyolefin other than the cycloolefin-based resin is polyethylene. Moreover, in the release film of the present invention, the film surface may be roughened by dispersing, into the resin-based material, particles comprising at least one type of material selected from the group including a cross-linked substance of a cycloolefin-based resin, an organic substance having a melting point and/or a glass transition point higher than that of the cycloolefin-based resin, and an inorganic substance. Moreover, in the release film of the present invention, it is preferable that the particles are particles comprising a thermal cross-linking substance of the cycloolefin-based resin. Moreover, in the release film of the present invention, it is preferable that the cycloolefin-based resin is a copolymer of ethylene and norbornene.

Moreover, in the release film of the present invention, it is preferable that the average thickness of the release film is in the range of 10 to 300 μm, and the ratio of the maximum and minimum values (maximum value/minimum value) of the thickness of this film is 2 or less. Moreover, in the release film of the present invention, it is preferable that the glass transition point (Tg) of the cycloolefin-based resin is 100° C. or more. Moreover, it is preferable that even if the release film of the present invention is superposed on an epoxy prepreg and pressed at 1 MPa for 5 minutes at 160° C. and thereafter cooled to the normal temperature, they do not adhere to each other.

The laminated release film of the present invention comprises an intermediate-layer resin film and the release film laminated on at least one side of the intermediate-layer resin film. Moreover, as the laminated release film of the present invention, it is preferable that the laminated release film is a three or more layer laminated release film having the release film as both surface layers thereof, and after applying a pressure of 2 MPa on this laminated release film for 5 minutes at 160° C., the length of a portion in which the intermediate-layer resin filmoverflowed from the end face of the surface layer is 2 mm or less. Moreover, in the laminated release film of the present invention, it is preferable that the intermediate-layer resin film comprises high density polyethylene. Moreover, in the laminated release film of the present invention, it is preferable that the intermediate-layer resin film comprises a resin-based material containing at least 10% by weight of a cross-linked polyolefin. Moreover, in the laminated release film of the present invention, it is preferable that the cross-linked polyolefin is a silane cross-linking polyolefin. Moreover, in the laminated release film of the present invention, it is preferable that the cross-linked polyolefin is a cross-linking polyethylene.

The production method of the release film of the present invention is a method, wherein the release film is obtained by supplying a resin-based material containing a cycloolefin-based resin into an extruding machine, melt-extruding it into a film shape from a T die whose lip clearance is adjusted to 0.7 mm or less, contacting it to a cooling roll controlled in the range of Tg±20° C. of the cycloolefin-based resin, thereby cooling and solidifying.

The production method of the laminated release film of the present invention is a method, wherein the laminated release film is obtained by melt-extruding into a film shape a resin-based material containing a cycloolefin-based resin and a resin-based material for forming an intermediate-layer resin film, with the use of a multilayer die having a feed block or a multi-manifold.

Moreover, it is preferable that when hot-press forming is performed for a laminate of a prepreg or heat-resistant film, and a copper clad laminate or a copper foil in the process of producing a printed wiring board or a flexible printed wiring board, the release film of the present invention is arranged in between a press hot plate and the laminate, and prevents this press hot plate from adhering to the printed wiring board or a flexible printed wiring board formed by hot press molding. Moreover, it is preferable that when hot-press forming is performed for a laminate of a prepreg or heat-resistant film, and a copper clad laminate or a copper foil in the process of producing a printed wiring board or a flexible printed wiring board, the laminated release film of the present invention is arranged in between a press hot plate and this laminate, and prevents this press hot plate from adhering to the printed wiring board or flexible printed wiring board formed by hot press molding. Moreover, it is preferable that when a prepreg comprising glass cloth, carbon fiber, or aramid fiber and epoxy resin is solidified in a press molding tool or in an autoclave, and then a molded product is produced, the release film of the present invention prevents the molding tool from adhering to the prepreg. It is preferable that when a prepreg comprising glass cloth, carbon fiber, or aramid fiber and epoxy resin is solidified in a press molding tool or in an autoclave, and then a molded product is produced, the laminated release film of the present invention prevents the molding tool from adhering to the prepreg.

According to the release film of the present invention, the examples indicate that an excellent release characteristic is obtained for a relatively wide range of objects (a blackening-processed copper face of FPC (a flexible printed wiring board), an adhesive face of polyimide (PI) cover lay film, and a contact face of epoxy prepreg). Moreover, in a case of a laminated release film, it is possible to give high cushioning characteristic by using a cross-linked polyolefin as the intermediate layer, and give a laminated release film having few overflows (flow-out) from the end faces of both surface layers of the intermediate-layer resin film when heated and pressed, and thus the release film having few difficulties in terms of the incineration and disposal after use can be provided.

### DETAILED DESCRIPTION OF THE PREFERRED EMBODIMENT

Hereafter, although the present invention will be described in detail in accordance with suitable embodiments, the present invention is not limited to the following embodiments.

First, the release film of the present invention is described. That is, the release film of the present invention comprises a resin-based material containing a cycloolefin-based resin. Then, it is preferable that such resin-based material comprises the cycloolefin-based resin, or is a resin composite having the cycloolefin-based resin as a main component. According to JP2004-156048 A, the cycloolefin-based resin is a high molecular compound whose principal chain comprising a carbon to carbon bond, wherein at least a part of the principal chain has a cyclic hydrocarbon structure. This cyclic hydrocarbon structure is introduced by using as a monomer a compound (cyclic olefin) having at least one olefin nature double bond in the cyclic hydrocarbon structure as represented by norbornene and tetracyclododecen. For such cycloolefin-based resin, a copolymer of a homopolymer of cyclic polyolefin and a chain polyolefin such as ethylene can be used.

As examples of the cyclic olefin used in the present invention, there are listed:

monocyclic olefin, such as cyclopentene, cyclohexene, cyclooctene; cyclopentadiene, 1, 3-cyclohexadiene;

bicyclicolefin, such asbicyclo [2.2.1] hepta-2-ene (popular name: norbornene), 5-methyl-bicyclo [2.2.1] hepta-2-ene, 5, 5-dimethyl-bicyclo [2.2.1] hepta-2-ene, 5-ethyl-bicyclo [2.2.1] hepta-2-ene, 5-butyl-bicyclo [2.2.1] hepta-2-ene, 5-ethylidene-bicyclo [2.2.1] hepta-2-ene, 5-hexyl-bicyclo [2.2.1] hepta-2-ene, 5-octyl-bicyclo [2.2.1] hepta-2-ene, 5-octadecyl-bicyclo [2.2.1] hepta-2-ene, 5-methylidyne-bicyclo [2.2.1] hepta-2-ene, 5-vinyl-bicyclo [2.2.1] hepta-2-ene, 5-propenyl-bicyclo [2.2.1] hepta-2-ene;

tricyclic olefin such as, tricyclo [4.3.0.1^{2,5}] deca-3, 7-diene (popular name: dicyclopentadiene), tricyclo [4.3.0.1^{2, 5}] deca-3-ene; tricyclo [4.4.0.1^{2,5}] undeca-3, 7-diene, or tricyclo [4.4.0.1^{2,5}] undeca-3, 8-diene, or tricyclo [4.4.0.1^{2,5}] undeca-3-ene which is partial hydroadditives of these (or additives of cyclopentadiene and cyclohexene); 5-cyclopentyl-bicyclo [2.2.1] hepta-2-ene, 5-cyclohexyl-bicyclo [2.2.1] hepta-2-ene, 5-cyclohexenylbicyclo [2.2.1] hepta-2-ene, 5-phenyl-bicyclo [2.2.1] hepta-2-ene;

tetracyclic olefin such as, tetracyclo [4.4.0.1^{2,5}.1^{7,10}] dodeca-3-ene (also simply called tetracyclododecen), 8-methyl tetracyclo [4.4.0.1^{2, 5}.1^{7,10}] dodeca-3-ene, 8-ethyltetracyclo [4.4.0.1^{2,5}.1^{7,10}] dodeca-3-ene, 8-methylidynetetracyclo [4.4.0.1^{2,5}.1^{7,10}] dodeca-3-ene, 8-ethylidenetetracyclo [4.4.0.1^{2,5}.1^{7,10}] dodeca-3-ene, 8-polymerstetracyclo [4,4.0.1^{2,5}.1^{7,10}] dodeca-3-ene, 8-propenyl-tetracyclo [4.4.0.1^{2, 5}.1^{7,10}] dodeca-3-ene;

polycyclic olefin such as, 8-cyclopentyl-tetracyclo [4.4.0.1^{2,5}.1^{7,10}] dodeca-3-ene, 8-cyclohexyl-tetracyclo [4.4.0.1^{2,5}.1^{7,10}] dodeca-3-ene, 8-cyclohexenyl-tetracyclo [4.4.0.1^{2,5}.1^{7,10}] dodeca-3-ene, 8-phenyl-cyclopentyl-tetracyclo [4.4.0.1^{2,5}.1^{7,10}] dodeca-3-ene; tetracyclo [7.4.1^{3, 6}0^{1,9}.0^{2,7}] tetradeca-4, 9, 11, 13-tetraene (also called 1, 4-methano-1, 4, 4a, 9a-tetrahydrofluorene), tetracyclo [8.4.1^{4, 7}.0^{1, 10}.0^{3, 8}] pentadeca-5, 10, 12, 14-tetraene (also called 1,4-methano-1,4,4a,5,10,10a-hexahydroanthracene); pentacyclo [6.6.1.1^{3,6}.0^{2,7}.0⁷.0^{9, 13}]-4-hexadecene, pentacyclo [6. 5.1.1^{3, 6}0.^{2, 7}.0^{9, 13}]-4-pentadecene, pentacyclo [7.4.0.0^{2, 7}.1^{3,6}.1^{10, 13}]-4-pentadecene; heptacyclo [8.7.0.1^{2,9.}1^{4,7}.1^{11,17}.0^{3,8.}0^{12,16}]-5-eicosene, heptacyclo [8.7.0.1^{2,9}.0^{3,8}.1^{4,7}.0^{12,17}.1^{13,16}]-14-eicosene; tetramer of cyclopentadiene. These cyclic olefins can be used independently or by combining two kinds or more.

As examples of α-olefin which can be copolymerized with cyclic olefin, there are listed ethylene or α-olefin or the like with carbon numbers 2 to 20, preferably carbon numbers 2 to 8, such as, ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4, 4-dimethyl-1-hexene, 4, 4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene. These α-olefins can be used independently or by combining two kinds or more.

There is no particular restriction for the polymerization method of the cyclic olefins, or cyclic olefin and α-olefin, and for the hydrogenation method of the obtained polymer, and these methods can be carried out according to known methods.

The cycloolefin-based resin used for the release film of the present invention is preferably an additive copolymer of ethylene and norbornene. With the additive copolymer of ethylene and norbornene, high Tg can be easily obtained by increasing the molar fraction of norbornene. Moreover, it is possible to generate in the film surface concavo-convex objects due to the thermal cross-linking by controlling the processing conditions. By roughening the film surface moderately, slippage characteristic with the objects can be improved.

Although the structure of such cycloolefin-based resin is not limited in particular and may be chain shaped, branch shaped, or cross-linking shaped, it is preferably straight chain shaped. Moreover, for the molecular weight of such cyclic olefin-based resin, the number average molecular weight according to the GPC method is 5,000 to 300,000, preferably 10,000 to 150,000, more preferably 15,000 to 100,000. If the number average molecular weight is too low, the mechanical strength tends to decrease, and if too high, the forming processability tends to decrease.

Moreover, the cycloolefin-based resin may include those which graft and/or copolymerize unsaturated compounds having polar groups (for example, a carboxyl group, an acid anhydride group, an epoxy group, an amide group, an ester groups, a hydroxyl group, or the like) to the above-described cycloolefin-based resin. For the above-described cyclic olefin-based resin, one kind can be used independently, or two or more kinds can be combined for use.

Tg of the cycloolefin-based resin used in the present invention is normally 50° C. or more, preferably 100° C. or more, further preferably 130° C. or more, and especially preferably 170° C. or more. When Tg is higher, the retention of the film shape and the release characteristic are more excellent at high temperature, however, if too high, the forming processability tends to be difficult. The upper-limit of Tg of the general cycloolefin-based resin is at 250° C. level. Moreover, two or more kinds of such cycloolefin-based resin having different Tg's can be combined for use.

For the release film of the present invention, although it is most preferable that as the resin-based material the cycloolefin-based resin is used independently, other thermoplastic resin may be blended for use within the range of not hindering the objectives of the present invention. Although the types of the resin to be blended are not limited in particular, polyolefin other than a cycloolefin-based resin is preferable. Moreover, among such polyolefin, various polyethylenes, for example, high density polyethylene, medium density polyethylene, low density polyethylene, metallocene polyethylene, and the resins denaturalized these resins to cross-link by means of heat, electron beams, or catalyst and the like, are further preferable. For the purpose of improving the toughness, various thermoplastic elastomer, such as olefin-based elastomer and styrene-based elastomer, and shock-resistant agents or the like may be blended. In a case of blending a resin which has a low affinity with a cycloolefin-based resin, it is preferable that a commercial compatibilizer or the like is used. The blend ratio of the resin to be blended is preferably 100 to 1 parts by weight, further preferably 45 to 5 parts by weight, and especially preferably 20 to 5 parts by weight per 100 parts by weight of the cycloolefin-based resin. If the blend ratio of the resin to be blended exceeds the upper limit, the detachability and heat resistance of the release film tend to decrease. Moreover, among such polyolefin, polyethylene is further preferable, and high density polyethylene is especially preferable. Moreover, the melt mass-flow rate (MFR) of such high density polyethylene is preferably 0.01 to 10.0, further preferably 0.1 to 3.0, and especially preferably 0.2 to 1.5. Whichever MFR is too high or too low, mixing with the cycloolefin-based resin uniformly tends to be difficult.

Moreover, in the release film of the present invention, the film surface may be roughened by dispersing, into the resin-based material, particles comprising at least one type of material selected from the group including a cross-linked substance of the cycloolefin-based resin, an organic substance having a melting point and/or a glass transition point higher than that of the cycloolefin-based resin, and an inorganic substance. Thus, for particles to be dispersed into the resin-based material, particles comprising a cross-linked substance of the cycloolefin-based resin; particles comprising an organic substance having a melting point and/or a glass transition point higher than that of the cycloolefin-based resin, such as silicon resin and Teflon (registered trademark) resin; and particles or fiber shaped particles comprising inorganic substances, such as talc, mica, silica, alumina, titanium oxide, zeolite, glass, montmorillonite, hectorite, aerosil, zinc oxide, iron oxide, carbon black, graphite, organic-metal salt, and metal oxide, can be used. Among these particles, particles comprising a thermal cross-linked substance of cycloolefin-based resin are used further preferably. Moreover, in the release film of the present invention, these particles can be blended for use, in the range of not hindering the effectiveness of the present invention. Moreover, in the release film of the present invention, an antioxidant, a plasticizer, an organic pigment, an inorganic pigment, a surfactant, a coupling agent, a polyethylene wax, a polypropylene wax, an alkyl ester acid ester wax, or the like may be blended in the range of not hindering the effectiveness of the present invention.

The average thickness of the release film (monolayer film) of the present invention is preferably 10 to 300 μm, further preferably 10 to 200 μm, especially preferably 10 to 100 μm, and most preferably 30 to 50 μm. And, the ratio of the maximum value to the minimum value (maximum value/minimum value) of the thickness of this film is preferably 2 or less, further preferably 1.5 or less, and especially preferably 1.1 or less. If the ratio of the maximum to the minimum values is too large, adhesion to the object will decrease in the portion where the film is thin. Then, if the adhesion to the object decreases, there are tendencies that the air which entered between the layers to the object expands and causes a burst, and that the pressing of the object comes to be insufficient. If the film is too thin, the strength of the film is insufficient and the film tends to be broken easily. On the other hand, if the film is too thick, flexibility of the film is deteriorated, and the adhesion to the object such as a prepreg, printed wiring board, or the like tends to be degraded.

Next, the laminated release film of the present invention is described. That is, the laminated release film of the present invention comprises an intermediate-layer resin film and the above-described release film laminated on at least one side of the intermediate-layer resin film. Since the laminated release film of the present invention is excellent in the release characteristic and cushioning characteristic, it is suitable for the so-called pad film when hot-press processing the printed wiring boards.

Although the laminated release film of the present invention may be two layer laminated release film wherein the release film described above is laminated on one side of the intermediate-layer resin film, it is preferable that the laminated release film is three or more layer laminated release film having the above-described release film as both surface layers thereof. In a case of the laminated release film, the average thickness of the surface layer (release-film layer) is typically 2 to 200 μm, preferably 10 to 100 μm, and furtherpreferably 20 to 100 μm.

When the surface layer (release-film layer) is too thin, the release-film layer tends to be broken easily. Then, if the release-film layer is broken, there will be inconvenience that the intermediate-layer resin film adheres to the object such as the prepreg, printed wiring board, or the like. On the other hand, if too thick, the flexibility of the film is deteriorated and the adhesion to the object such as the prepreg, the printed wiring board, or the like tends to decrease. Moreover, in a case of three or more layer laminated release film, it is preferable that the surface layer (release-film layer) is thinner than the intermediate layer (intermediate-layer resin film layer) Moreover, the average of the total thickness of such laminated release film is typically 20 μm to 2 mm, preferably 50 μm to 1 mm, and furtherpreferably 100 to 500 μm. If too thin, the strength and cushioning characteristic of the film tend to be insufficient. On the other hand, if too thick, there will be inconvenience that the flexibility of the film is deteriorated, and that the resin of the intermediate layer easily overflows from the film end face, or the like.

The fluidity of the intermediate-layer resin film concerning the laminated release film of the present invention can be evaluated by measuring the length (flow-out distance) of the overflow portion from the end face of the laminated release film. That is, after applying a pressure of 2 MPa to this laminated release film for 5 minutes at 160° C., the length (flow-out distance) of the portion which is a portion of the intermediate-layer resin film overflowed (flow-out) from the end face of the surface layer is normally 5 mm or less, preferably 2 mm or less, further preferably 1 mm or less, and especially preferably 0.5 mm or less. If such flow-out distance is long, there are tendencies that the intermediate-layer resin film adheres to the objects such as the substrate, and causes contamination, and that moderate cushioning characteristic can not be obtained.

Although the resin-based material for forming the intermediate-layer resin film concerning the laminated release film of the present invention is not limited in particular, it is preferable to use those having an excellent adhesive characteristic to the cycloolefin-based resin. Moreover, as such resin-based material, it is preferable to use those having flexibility and moderate cushioning characteristic at operating temperature, on the other hand, the resin of the intermediate layer is hard to flow out of the end face of the laminated film (hard to fluidize) at operating temperature. Furthermore, in a case of melt-extruding into a film shape using a multilayer die having a feed block or a multi-manifold, and coextrude-forming, it is preferable to use a resin-based material whose resin viscosity at operating temperature is close to that of the cycloolefin-based resin.

As such resin-based material, an olefin-based resin is preferable, and a polyethylene-based resin is more preferable from the viewpoint of adhesive characteristic between layers. Then, as such resin-based material, from a viewpoint of fluidity, a high density polyethylene, a thermoplastic elastomer, or a cross-linked resin are further more preferable, and those containing at least 10% by weight of cross-linked polyolefin is especially preferable. Although as the method of cross-linking, known techniques such as silane cross-linking and electron beam cross-linking, can be used, the method of silane cross-linking is preferable. Moreover, the use of a water cross-linking type resin (for example, Product name LINKRON manufactured by Mitsubishi Chemical Corporation, or the like) allows the cross-linking resin layer to be formed easily. Water cross-linking polyethylene is especially preferable among these water cross-linking resins.

Although such water cross-linking resin may be blended with other thermoplastic resins for use within the range of not hindering the objectives of the present invention from the viewpoints of anti-gelling during the film processing and the resin cost, preferably it is used independently. For the kinds of other thermoplastic resins to blend with such water cross-linking resin, there is especially no restrictions in particular, however, olefin-based resin is preferable, and various polyethylene, such as a high density polyethylene, a medium density polyethylene, a low density polyethylene, and metallocene polyethylene are especially preferable. Moreover, for the purpose of improving toughness, various thermoplastic elastomers such as an olefin-based elastomer and a styrene-based elastomer, or shock-resistant agents or the like may be blended. The blend ratio of other thermoplastic resin to be blended with such water cross-linking resin is preferably 90% or less by weight, further preferably 70% or less by weight, especially preferably 30% or less by weight. Since the intermediate-layer resin film will be easily fluidized as the blend ratio of other thermoplastic resins increases, the intermediate-layer resin film tends to overflow from the edge of the laminated film, and cause contamination of the object such as the printed wiring board or the like. Moreover, the gel fraction in a case of using such water cross-linking resin is typically 10% or more, preferably 30% or more, and especially preferably 50% or more. Moreover, in a case of using such water cross-linking resin, in order to facilitate the cross-linking speed after forming, it is preferable to use those blended with the resin having a high steam transmittance rate, such as polyethylene or the like, as the resin-based material for the surface layer (release-film layer). By selecting these resins, the flow-out of the intermediate-layer resin film is suppressed without applying the processing such as heat sealing or the like to the end face of the laminated release film.

Moreover, in the laminated release film of the present invention, the resin-based material for forming the intermediate-layer resin film may contain further additives. Although such additives are not limited in particular, a fine powder of silicon resin or Teflon (registered trademark) resin; a powder-like or fiber-like filler of talc, mica, silica, alumina, titanium oxide, zeolite, glass, montmorillonite, hectorite, aerosil, zinc oxide, iron oxide, carbon black, graphite, organic-metal salt, metal oxide, or the like can be blended for use in the range of not hindering the effectiveness of the present invention. Moreover, in the release film of the present invention, antioxidant, plasticizer, organic pigment, inorganic pigment, surfactant, coupling agent, polyethylene wax, polypropylene wax, alkyl acid ester wax, or the like may be blended, but not blended enough to hinder the effectiveness of the present invention.

Although it is preferable that the surface of the release film or laminated release film of the present invention described above has smoothness, slippery characteristic and anti blocking characteristic, or the like required for handling, and moderate embossing patterns may be prepared at least on one side thereof for the purpose of air escape in hot-press forming.

As a target for release characteristic of the release film or laminated release film of the present invention, it is preferable that even if the film is superposed on an epoxy prepreg, and pressed at 1 MPa for 5 minutes at 160° C., thereafter cooled to normal temperature, they do not adhere to each other.

Although the method of forming the release film of the present invention is not limited in particular, it can be formed by a melt extrusion method normally. Specifically, the resin-based material containing cycloolefin-based resin is supplied to an extruding machine, and melt-extruded into a film shape from a T die whose lip clearance is adjusted to 1 mm or less, preferably to 0.7 mm or less, and is then contacted to a cooling roll, which is controlled in the range of Tg (glass transition point) ±20° C. of the cycloolefin-based resin, and is cooled and solidified for forming. The melt extrusion method is not limited in particular, and there are listed, for example, a T die extrusion method, and an inflation and deflation extrusion method using a cyclic die, or the like.

The method of producing the laminated release film of the present invention is not limited in particular, and known methods, such as a method of producing each film separately and bonding them by a dry laminate or the like, a method of coextrude-forming, or the like, can be used. For example, by melt-extruding into a film shape using a multilayer die having a feed block or a multi-manifold, the laminated release film is obtained. From the viewpoint of productivity, the coextrude forming is especially preferable.

In a case of using a multilayer cyclic die, a cyclic molded product whose outer layer is made a cycloolefin-based resin is extruded, suppressed by a pinch roll or the like, and one sheet of laminated release film can be formed by superposing two sheets of films. In order to improve the adhesive characteristic between layers of the laminated release film, an adhesive resin layer may be prepared in between the release film and intermediate-layer resin film.

When hot-press forming is performed for a laminate of a prepreg or heat-resistant film, and a copper clad laminate or a copper foil in the process of producing printed wiring boards or flexible printed wiring boards, the release film or laminated release film of the present invention is arranged in between a press hot plate and this laminate, and is suitably used as a film for preventing this press hot plate from adhering to the printed wiring board or the flexible printed wiring board formed by hot press molding. In addition, in the case where a plurality of laminates are included, the release film or laminated release film of the present invention may be arranged also in between the laminates. Furthermore, when solidifying the prepreg comprising glass cross, carbon fiber, or aramid fiber and epoxy resin, in a press molding tool or in an autoclave, and thereby producing molded products such as fishing rods and golf club shafts, it is also useful as the release film or laminated release film for preventing adhesion between the molding tool and the prepreg.

### EXAMPLES

Hereinafter, the present invention will be described more specifically taking examples and comparative examples, however, the present invention is not limited to the following examples. Methods of measuring physical properties are as follows.

Average thickness measurement:

The thickness of films was measured with a dial gage thickness meter (Product name: DG-911 manufactured by ONO 50 KKI Co., Ltd.). The thickness was measured at a total of 25 measurement points of vertically 5 points and horizontally 5 points, at 100 mm intervals from a film which is an arbitrarily cut out film of 550 mm×550 mm dimension, and average value, maximum value, minimum value, and maximum value/minimum value were calculated.

Detachability:

A release film, which is cut out into a 100 mm×50 mm size, is superposed on an object (an epoxy prepreg), and after applying a pressure of 1 MPa for 5 minutes with a pressing machine that is adjusted to 150 to 230° C. (160° C.), a sample thereof was taken out and sufficiently cooled at room temperature, and then the release film was peeled off from the object by hand. At this time, if having been peeled off easily almost without applying manual force, it is ranked as “A”. If having been peeled off by applying manual force, it is ranked as “B”. If having not been peeled off, it is ranked as “C”. As the objects, three kinds: a blackening-processed copper face of FPC (a flexible printed wiring board manufactured by NIHON-MULTI Co., Ltd.), an adhesive coated face and a non-adhesive coated face of polyimide (PI) cover lay film (Product name: NIKAFLEX CISA manufactured byNikkan Industries Co., Ltd.), and an epoxy prepreg sheet (a carbon fiber reinforced epoxy prepreg manufactured by Sakai Sangyo Co., Ltd.), were used. Among these, the epoxy prepreg sheet was used as the object, and the condition of being superposed on a sample release film and being pressed at 1 MPa, for 5 minutes at 160° C. was a standard for the detachability.

Fluidity of a laminated release film (flow-out distance of the intermediate layer):

After applying a pressure of 2 MPa for 5 minutes on a laminated release film which is cut out into 100 mm×100 mm size by a pressing machine which is adjusted to 160° C., a sample thereof was taken out and sufficiently cooled at room temperature, and then the length (flow-out distance) of a portion of the intermediate-layer resin film that overflowed from the mold release layer of the surface layer was measured. The length of the portion having the largest overflow in the four sides of each sample is defined as a flow-out distance (mm) of the intermediate layer of this sample. Ten samples for which these values are to be measured were prepared and the average value (arithmetic mean) for 10 measured values was calculated.

### Examples 1 to 4, Comparative Examples 1 to 3

The resin shown in Table 1 was supplied to a single screw extruder, and the melted resin was extruded from a T type dice having a lip-clearance of 0.7 mm, and then was cooled with a cooling roll, thereby obtaining a release film with an average thickness of 50 μm. The release films obtained in Examples 1 to 4 were excellent in the anti-staining characteristic. In addition, the evaluation results of the detachability are shown in Table

### Example 5

70% by weight of cyclic polyolefin copolymer (TOPAS 6017) and 30% by weight of water cross-linking high density polyethylene (LINKRON 650N) were mixed in pellet blend, and supplied to a single screw extruder, and the melting resin was extruded from a T type dice having a lip-clearance of 0.7 mm, and was cooled with a cooling roll to obtain a release film having an average thickness of 50 μm. The obtained film was processed in a hot water of 80° C. for 3 hours to make a release film. The release film obtained in Example 5 was excellent in the anti-staining characteristic. The evaluation results of the detachability are shown in Table 1.

### Example 6

In the same way as Example 5 except that 30% by weight of water cross-linking high density polyethylenes used in Example 5 was replaced by HDPE, a release film with an average thickness of 50 μm was obtained. The release film obtained in Example 5 was excellent in the anti-staining characteristic. The evaluation results of the detachability are shown in Table 1.

In the release film obtained in Examples 1 to 6 and Comparative examples 1 to 3, the ratio of the maximum value/minimum value of the film thickness was 1.1 or less.

TABLE 1

| | | | Objective sheet | | | | | | | |
|---|---|---|---|---|---|---|---|---|---|---|
| | | | | | | | | | Contact face | |
| | | | Blackening-processed | | | Adhesive coated face | | | of epoxy | |
| | | | copper face of FPC | | | of PI cover lay film | | | prepreg | |
| | | | Press condition | | | | | | | |
| | | | 160° C. | 190° C. | | | | | 130° C. | |
| | | Resin | 5 min. | 5 min. | 230° C. 5 min. | 160° C. 5 min. | 190° C. 5 min. | 230° C. 5 min. | 30 min. | 170° C. 5 min. |
| Example | 1 | Resin1 | A | A | A | A | A | A | A | A |
| | 2 | Resin2 | A | A | A | A | A | A | A | A |
| | 3 | Resin3 | A | A | A | A | A | A | A | A |
| | 4 | Resin4 | A | A | A | A | A | A | A | A |
| | 5 | Resin3/Resin6 = | A | A | B | A | A | B | A | A |
| | | 70/30 wt % | | | | | | | | |
| | 6 | Resin3/HDPE = | A | A | B | A | A | B | A | A |
| | | 70/30 wt % | | | | | | | | |
| Comparative | 1 | ETFE | A | A | A | A | A | A | A | A |
| example | 2 | PVDF | B | C | C | C | C | C | C | C |
| | 3 | PBT | A | A | B | C | C | C | C | C |

In Table 1 described above and Tables 2 to 5 to be described later, each resin is as follows.

Resin 1 is cyclic polyolefin copolymer (TOPAS 6013, Tg=140° C., manufactured by Poly Plastics Co., Ltd.). Resin 2 is cyclic polyolefin copolymer (TOPAS 6015, Tg=160° C., manufactured by Poly Plastics Co., Ltd.). Resin 3 is cyclic polyolefin copolymer (TOPAS 6017, Tg=180° C., manufactured by Poly Plastics Co., Ltd.). Resin 4 is cyclic polyolefin polymer (ZEONOR 1600R, Tg=160° C., manufactured by ZEON Corp.). Resin 5 is water cross-linking low density polyethylene (LINKRON 710N manufactured by Mitsubishi Chemical Corporation). Resin 6 is water cross-linking high density polyethylene (LINKRON 650N manufactured by Mitsubishi Chemical Corporation). ETFE is ethylene tetrafluoroethylene copolymer (Aflon C88A manufactured by Asahi Glass Co., Ltd.). PVDF is polyvinylidene di-fluoride (KF#1000 manufactured by KUREHA Corp.). HDPE is high density polyethylene (HI-ZEX 3300F, MFR=1.1, manufactured by Mitsui Chemicals Inc.). HDPE (2) is high density polyethylene (Novar tech HY530, MFR=0.55, manufactured by Japan Polyethylene Corporation). PBT is polybutylene terephthalate (DURANEX 700FP manufactured by WinTech Polymer Ltd.).

As apparent also from the results described in the above table 1 , for the release films obtained in Examples 1 to 4, excellent release characteristics were obtained for every object (the blackening-processed copper face of FPC (flexible printed wiring board), an adhesive coated face of polyimide (PI) cover lay film, and a contact face of epoxy prepreg) in a wide range of temperature conditions. Also for the release film obtained in Example 5 in which water cross-linking high-density polyethylene resin is added to the cyclic olefin-based resin, excellent detachability was obtained at relatively lower temperatures. In addition, as for the release film obtained in Examples 1 to 6, the evaluation results of the detachability from the non-adhesive coated face of polyimide (PI) cover lay film at 230° C. was “A”. On the other hand, the film obtained in Comparative example 1 had excellent detachability, but because it is a fluorine containing resin, a toxic gas is generated in its incineration or the like after use. For this reason it has a disadvantage of a difficulty at a disposal. Moreover, for the films obtained in Comparative example 2 and Comparative example 3, the detachability from epoxy prepreg or cover lay film was poor. Therefore, it was confirmed that the release film of the present invention has excellent heat resistance and release characteristic.

### Examples 7 to 11

The resin shown in Table 2 was co-extruded using a multi-manifold multilayer T die and a single screw extruder (used for front and rear face layers, and for intermediate layers), to obtain a laminated release film with an average thickness of 250 μm (the surface-layer thickness of 40 μm, intermediate-layer of 170 μm, rear face layer thickness of 40 μm). Furthermore, the obtained film was processed in a hot water of 80° C. for 3 hours to make a release film. The laminated release films obtained in the Examples 7 to 11 had excellent cushioning characteristic. Moreover, in the laminated release films obtained in Examples 7 to 11, a ratio of the maximum value/minimum value of the film thickness was 1.1 or less. In addition, as the method of blending a plurality of resins, a method of mixing by pellet blending was used. The evaluation results of fluidity of the intermediate layer is shown in Table 2.

TABLE 2

| | | | | Flow-out |
|---|---|---|---|---|
| | | | | distance (mm) |
| | | | | of intermediate |
| | | | | layer under |
| | | Resin | | press conditions: |
| | | Surfaces | Intermediate | at 160° C. |
| | | (both sides) | layer | for 5 min. |
| Example | 7 | Resin2 | Resin5 | 0.6 |
| | 8 | Resin2 | Resin6 | 0.3 |
| | 9 | Resin2 | Resin5/HDPE = | 1.0 |
| | | | 50/50 wt % | |
| | 10 | Resin2 | Resin6/HDPE = | 0.8 |
| | | | 50/50 wt % | |
| | 11 | Resin2 | HDPE | 5.0 |

As apparent also from the results described in Table 2, in the laminated release film obtained in Example 11 in which HDPE was used for an intermediate layer, the flow-out of the intermediate-layer resin film was large, however, the flow-out was suppressed to one tenth of that in Example 11, in the laminated release film obtained in Example 7 and Example 8 in which water cross-linking polyethylene was used. Moreover, also in the laminated release film obtained in Example 9 and Example 10 in which HDPE is blended into water cross-linking polyethylene, the flow out of the intermediate-layer resin film did not increase significantly. Therefore, in the laminated release film of the present invention, it was confirmed that the intermediate-layer resin film hardly flow out from the film end face.

### Examples 12 to 17

The resin shown in Table 3 was supplied to a single screw extruder, and the melting resin was extruded from a T type dice having a lip-clearance of 0.7 mm, and was cooled with a cooling roll to obtain a release film with an average thickness of 50 μm. To the release films obtained in Examples 12 to 17, contaminants are difficult to adhere, the resin films are excellent in the anti-staining characteristic. Moreover, the release films obtained in Examples 12 to 17 had higher flexibility as compared with the release films obtained in Examples 2 and 3 in which HDPE (2) is not added into the cyclic olefin-based resin, and were excellent in the handling ability. Furthermore, as the addition of HDPE (2) increased, the flexibility and handling ability of the release film improved. Moreover, in the release films obtained in Examples 12 to 17, the ratio of the maximum value/minimum value of the film thickness was 1.1 or less. In addition, as the method of blending a plurality of resins, a method of mixing by pellet blending was used. The evaluation results of the release characteristic is shown in Table 3.

TABLE 3

| | | | Objective sheet | | | | | | | |
|---|---|---|---|---|---|---|---|---|---|---|
| | | | Blackening | | | | | | Contact face | |
| | | | processed copper | | | Adhesive coated face | | | of epoxy | |
| | | | face of FPC | | | of PI cover lay film | | | prepreg | |
| | | | Press condition | | | | | | | |
| | | | 160° C. | 190° C. | | | | | 130° C. | |
| | | Resin | 5 min. | 5 min. | 230° C. 5 min. | 160° C. 5 min. | 190° C. 5 min. | 230° C. 5 min. | 30 min. | 170° C. 5 min. |
| Example | 12 | Resin2/HDPE(2) = | A | B | B | A | B | B | A | A |
| | | 70/30 wt % | | | | | | | | |
| | 13 | Resin2/HDPE (2) = | A | A | B | A | A | B | A | A |
| | | 80/20 wt % | | | | | | | | |
| | 14 | Resin2/HDPE (2) = | A | A | B | A | A | B | A | A |
| | | 90/10 wt % | | | | | | | | |
| | 15 | Resin3/HDPE (2) = | A | A | A | A | A | A | A | A |
| | | 70/30 wt % | | | | | | | | |
| | 16 | Resin3/HDPE (2) = | A | A | A | A | A | A | A | A |
| | | 80/20 wt % | | | | | | | | |
| | 17 | Resin3/HDPE (2) = | A | A | A | A | A | A | A | A |
| | | 90/10 wt % | | | | | | | | |

As apparent also from the results described in Table 3, for the release films obtained in Examples 12 to 17 in which HDPE (2) is added into the cyclicolefin-based resin, excellent detachability was obtained at relatively lower temperatures. In addition, as for the release films obtained in Examples 12 to 17, the evaluation results of detachability from a non-adhesive coated face of polyimide (PI) cover lay film at 230° C. was “A”. Moreover, specifically, for the release films obtained in Examples 15 to 17, in a wide range of temperature conditions, excellent release characteristic to every object (the blackening-processed copper face of FPC (flexible printed wiring board), an adhesive coated face of polyimide (PI) cover lay film, and contact face of epoxy prepreg) were obtained. Therefore, it was confirmed that the release film of the present invention has excellent heat resistance and release characteristic.

### Examples 18 to 24

The resin shown in Table 4 was co-extruded using a feed block type multilayer T die and a single shaft screw extruder (used for front and rear face layers, and used for the intermediate layers), to obtain a laminated release film with an average thickness of 250 μm (surface-layer thickness of 40 μm, intermediate-layer thickness of 150 μm, rear-face layer thickness of 50 μm). The laminated release films obtained in the Examples 18 to 24 had excellent cushioning characteristic. Moreover, as the addition of HDPE (2) increases, the flexibility and handling ability of the release film improved. Moreover, in the laminated release films obtained in Examples 18 to 24, a ratio of the maximum value/minimum value of the film thickness was 1.1 or less. In addition, as the method of blending a plurality of resins, a method of mixing in pellet blend was used. The evaluation results of fluidity of the intermediate layer is shown in Table 4.

TABLE 4

| | | | | Flow out |
|---|---|---|---|---|
| | | | | distance (mm) |
| | | | | of intermediate |
| | | | | layer under |
| | | Resin | | press condition: |
| | | Surfaces | Intermediate | at 160° C. |
| | | (both sides) | layer | for 5 min. |
| Example | 18 | Resin2/HDPE(2) = | HDPE(2) | 2.0 |
| | | 70/30 wt % | | |
| | 19 | Resin2/HDPE(2) = | HDPE(2) | 1.9 |
| | | 80/20 wt % | | |
| | 20 | Resin2/HDPE(2) = | HDPE(2) | 1.8 |
| | | 90/10 wt % | | |
| | 21 | Resin3/HDPE(2) = | HDPE(2) | 1.6 |
| | | 70/30 wt % | | |
| | 22 | Resin3/HDPE(2) = | HDPE(2) | 1.6 |
| | | 80/20 wt % | | |
| | 23 | Resin3/HDPE(2) = | HDPE(2) | 1.5 |
| | | 90/10 wt % | | |
| | 24 | Resin3/HDPE(2) = | Resin3/ | 0.9 |
| | | 80/20 wt % | HDPE(2) = | |
| | | | 20/80 wt % | |

As apparant also from the results described in Table 4, the flow out of the intermediate-layer resin film was suppressed also in the laminated release film obtained in Examples 18 to 23 in which HDPE (2) was used for the intermediate layer. Especially, in addition, in the laminated release film obtained in Example 24 in which cyclic polyolefin copolymer was blended into HDPE, the flow out of the intermediate-layer resin film was suppressed extremely being sufficient. Therefore, in the laminated release film of the present invention, it was confirmed that the intermediate-layer resin film hardly flow out from the film end face.

### Examples 25 and 26

A laminated release film (Example 25) with an average thickness of 50 μm (surface-layer thickness 1 μm, intermediate-layer thickness of 30 μm, rear face thickness of 1 μm) was obtained in the same way as Example 22 except that the line speed (take-out speed of the melting resin) was increased five times as that in Example 22. Moreover, the laminated release film (Example 26) with an average thickness of 50 μm (surface-layer thickness 1 μm, intermediate-layer thickness of 30 μm, rear face thickness of 10 μm) was obtained in the same way as Example 24 except that the line speed (take-out speed of the melting resin) was increased five times as that in Example 24. The laminated release films obtained in Examples 25 and 26 had excellent cushioning characteristic and were excellent in the anti-staining characteristic. Moreover, in the laminated release films obtained in Examples 25, 26, a ratio of the maximum value/minimum value of the film thickness was 1.1 or less. In addition, as the method of blending a plurality of resins, a method of mixing in pellet blend was used.

TABLE 5

| | | | Objective sheet | | | | | | | |
|---|---|---|---|---|---|---|---|---|---|---|
| | | | | | | | | | Contact face | |
| | | | Blackening-processed | | | Adhesive coated face | | | of epoxy | |
| | | | copper face of FPC | | | of PI cover lay film | | | prepreg | |
| | | | Press condition | | | | | | | |
| | | | 160° C. | 190° C. | 230° C. | 160° C. | | | 130° C. | |
| | | Resin | 5 min. | 5 min. | 5 min. | 5 min. | 190° C. 5 min. | 230° C. 5 min. | 30 min. | 170° C. 5 min. |
| Example | 25 | Three-layer film | A | A | A | A | A | A | A | A |
| | | with the same | | | | | | | | |
| | | resin composition | | | | | | | | |
| | | as Example 22 | | | | | | | | |
| | 26 | Three-layer film | A | A | A | A | A | A | A | A |
| | | with the same | | | | | | | | |
| | | resin composition | | | | | | | | |
| | | as Example 24 | | | | | | | | |

As apparent also from the results described in Table 5, for the release films obtained in Examples 25, 26, in a wide range of temperature conditions, excellent release characteristic to either object (the blackening-processed copper face of FPC (flexible printed wiring board), an adhesive coated face of polyimide (PI) cover lay film, and a contact face of epoxy prepreg) were obtained. In addition, as for the release films obtained in examples 25, 26, the evaluation results of detachability from a non-adhesive coated face of polyimide (PI) cover lay film at 230° C. was “A”. Accordingly, it was confirmed that the release film of the present invention has excellent heat resistance and release characteristic.

1-23. (canceled)

24. A laminated release film comprising an intermediate-layer resin film and the release film comprising a first resin-based material containing a cycloolefin-based resin as a main component, the release film being laminated to both sides of the intermediate-layer resin film.

25. The laminated release film according to claim 24, wherein the resin-based material comprises a resin composite containing the cycloolefin-based resin as a main component, and wherein the resin composite contains 1 to 100 parts by weight of polyolefin other than the cycloolefin-based resin, per 100 parts by weight of the cycloolefin-based resin.

26. The laminated release film according to claim 25, wherein the polyolefin other than the cycloolefin-based resin is polyethylene.

27. The laminated release film according to claim 26, wherein the polyethylene is a high density polyethylene.

28. The laminated release film according to claim 24, wherein the cycloolefin-based resin is a copolymer of ethylene and norbornene.

29. The laminated release film according to claim 24, wherein the glass transition point (Tg) of the cycloolefin-based resin is 100° C. or more.

30. The laminated release film according to claim 24, wherein the average thickness of the release film is in a range of 10 to 300 μm, and a ratio of the maximum and minimum values (maximum value/minimum value) of the thickness of this film is 2 or less.

31. The laminated release film according to claim 24, wherein even if the release film is superposed on an epoxy prepreg and pressed at 1 MPa for 5 minutes at 160° C. and thereafter is cooled to normal temperature, they do not substantially adhere to each other.

32. The laminated release film according to claim 24, wherein the laminated release film is a three or more layer laminated release film having the release film at both surface layers thereof, and wherein after applying a pressure of 2 MPa on this laminated release film for 5 minutes at 160° C., the length of a portion in which the intermediate-layer resin film overflowed from the end face of the surface layer is 2 mm or less.

33. The laminated release film according to claim 24, wherein the intermediate-layer resin film comprises a high density polyethylene.
